(19) United States
(12) Patent Application Publication
(10) Pub. No.: US 2023/0359928 A1
(43) Pub. Date: Nov. 9, 2023

(54) TRANSFER LEARNING USING DECISION TREE BASED MACHINE LEARNING MODELS

(71) Applicant: ADOBE INC., San Jose, CA (US)

(72) Inventors: Yuting CHEN, San Jose, CA (US); Fengqi YANG, San Diego, CA (US); Hsin-Ya LOU, San Jose, CA (US); Bo PENG, San Jose, CA (US)

(21) Appl. No.: 17/735,803

(22) Filed: May 3, 2022

(51) Int. Cl. G06N 20/00

(52) U.S. Cl. CPC G06N 20/00

(57) ABSTRACT

A computerized method includes training a first decision tree based model on a first set of data to generate a first trained decision tree based model having a first set of decision trees. The first trained decision tree based model outputs a first prediction based on receiving an input. The method includes training a second decision tree based model on a second set of data to generate a second trained decision tree based model. The second trained decision tree based model comprises the first set of decision trees and a second set of decision trees determined from training the second decision tree based model. The second trained decision tree based model outputs a second prediction based on receiving the input. The method includes training a logistic model to output a final prediction in response to receiving the first prediction and the second prediction.

### BACKGROUND

Machine learning is used in many applications to make predictions about an event. To make predictions based on relevant data, machine learning models are regularly trained with new data. While there are various types of machine learning models, one popular class of machine learning includes decision tree based models.

### SUMMARY

At a high level, aspects described herein relate to using transfer learning using decision tree based models.

A first decision tree based model can be trained on a first set of data. A second decision tree based model can be trained on a second set of data. The second decision tree based model includes a first set of decision trees from the first trained decision tree based model and a second set of decision trees that is determined from training the second trained decision tree based model on the second set of data.

The first trained decision tree based model outputs a first prediction responsive to receiving an input. The second decision tree based model outputs a second prediction responsive to receiving the same input. Each of the first prediction and the second prediction are provided as inputs to a logistic model. The logistic model can be trained on outputs of the first trained decision tree based model and the second trained decision tree based model. The logistic model outputs a final prediction responsive to receiving the first prediction and the second prediction.

The transfer learning methods using decision tree based models described herein can be used to predict various outcomes, including a probability that a user, having a user account associated with a subscription service, will cancel the subscription service within a pre-defined period of time. By training the first decision tree based model and the second decision tree based model, and the logistic model on a labeled dataset comprising user attributes and an indication of whether the user canceled a subscription, the models described herein can be used to make a prediction on whether a user will cancel a subscription within a forthcoming period of time.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 is an example operating environment in which decision tree based models using transfer learning can be employed, in accordance with an aspect described herein;

FIG. 2 is an example process of training a first trained decision tree based model and a second trained decision tree based model, in accordance with an aspect described herein;

FIG. 3 is an example process of training a logistic model, in accordance with an aspect described herein;

FIG. 4 is a diagram of an example process that can be performed by the technology of FIG. 1 to make a final prediction, in accordance with an aspect described herein;

FIG. 5 is a flow diagram of an example method for training models for use in making predictions, in accordance with an aspect described herein;

FIG. 6 is flow diagram of an example method for using trained models to make predictions, in accordance with an aspect described herein; and

FIG. 7 is an example computing device suitable for implementing the described technology, in accordance with an embodiment described herein.

### DETAILED DESCRIPTION

Decision tree based models are machine learning models that use decision trees to make predictions. In many implementations of machine learning using decision trees, it is beneficial to train the model on new data to keep the output predictions current.

To train a model on new data, a new decision tree based model can be trained altogether on the new dataset or an existing dataset to which the new data is added. This results in a newly trained decision tree based model for making predictions. Using a different method, decision tree based models can be “boosted” by the new data. This usually involves training an existing decision tree based model by adding new decision trees learned from the new data to existing decision trees learned from a previous dataset.

In some use cases, however, downstream processes that rely on the predictions output by a trained decision tree based model can be sensitive to changes in the output between predictions. That is, downstream processes may be highly affected by small changes between outputs. As such, it may be beneficial to reduce the deviation from prediction to prediction, while still using a model that is trained on newer data.

One example method that achieves this benefit, among others, and that can be practiced from the description provided herein, includes training a first decision tree based model on a first set of data to generate a first decision tree based model. Based on the training, the first trained decision tree based model includes a first set of decision trees. The first trained decision tree based model can be “boosted.” To do so, a second decision tree based model is trained on a second set of data. The second set of data can be collected at a time later than the first set of data and be more temporally relevant. As a result of training the second decision tree based model, a second trained decision tree based model is generated and comprises a second set of decision trees. The second set of decision trees includes decision trees from the first set of decision trees along with additional decision trees that are learned from training the second trained decision tree based model.

A first prediction can be generated using the first trained decision tree based model by providing the first trained decision tree based model with an input. The same input can also be provided to the second trained decision tree based model to generate a second prediction.

The first prediction and the second prediction can be provided as inputs into a logistic model, such as a logistic classifier. The logistic model can be trained using at least a portion of the second set of data. The logistic model outputs a final prediction, such as a probability of an event or a predicted classification for the input.

By using this type of method, the final prediction is less likely to deviate from prediction to prediction, while still being the result of a machine learning process involving temporally relevant data. This is beneficial for downstream applications that are sensitive to changes in the machine learning output, as previously described.

Another benefit to this machine learning approach is that the effect on the output from decision tress learned at an earlier stage is less diminished. For instance, in applications where only a later prediction from a boosted model is used, the earlier learned decision trees have less effect on the prediction as the model is continually boosted with new trees from new data. In some embodiments, although it is still beneficial to train the model on new data, the earlier learned decision trees are still relevant. Methods provided herein better capture the predictive capability of these earlier learned decision trees by getting an output prediction from a first model and an output prediction from a second boosted model. As such, the first prediction, which is affected more greatly by the earlier learned decision trees, along with the second prediction, are used to generate the final output. These models have been found to produce a smooth, gradual change from prediction to prediction, which can reduce large downstream changes caused by more divergent predictions.

One example use case in which the technology has been particularly beneficial is determining a probability that a user account associated with a subscription service will cancel within a particular timeframe, sometimes referred to within the industry as “churn.” To employ this technology, user attributes (such as length of subscription, location, cost, service usage event data, and so forth) associated with an account can be identified. The user account can be labeled to indicate whether the user account has canceled a subscription service associated with the account. The labeled dataset can be used to train a first decision tree based model to generate a first trained decision tree based model configured to receive user attributes as an input and predict the probability that an associated user account will cancel the subscription service.

A second decision tree based model can be trained using a newer set of labeled data comprising user attributes and labeled indications of whether the user account canceled a subscription service. The second trained decision tree based model can comprise decision trees learned from the previous training and decision trees learned from the new dataset. In this way, the second trained decision tree based model is configured to receive user attributes as an input and predict the probability that an associated user account will cancel the subscription service. The predictions from each model are provided as inputs to a logistic model, such as a logistic classifier. The logistic classifier is trained on outputs of the first decision tree based model and the second decision tree based model, and is configured to output a final prediction on whether the user account will cancel the subscription service using the input first and second predictions.

It will be realized that the method previously described is only an example that can be practiced from the description that follows, and it is provided to more easily understand the technology and recognize its benefits. Additional examples are now described with reference to the figures.

As noted, the example method may reduce the variation between predictions, thus providing benefits to downstream processes that are greatly affected by changes in the ultimate predictions. At the same time, however, the models can be trained on newer and more relevant data. Ultimately, this provides for a highly precise, yet accurate, decision model. In part, these benefits are derived from the particular architecture of using the first trained decision tree based model and the second trained decision tree based model, which is trained, e.g., boosted, with the new dataset. This example provides a first trained decision tree based model having a first set of decision trees and a second trained decision tree based model having a second set of decision trees, where the second set of decision trees includes decision trees from the first set of decision trees and new decision trees learned from the new, more relevant data. This transfer learning process, whereby the second set of decision trees includes decision trees from the first set of decision trees, helps reduce some variation between predictions. However, aspects of the technology further train a logistic model using the output of each decision tree based model. The logistic model provides an ultimate prediction. In doing so, the logistic model takes into account each output, thus providing a final prediction that is based on the output determined by both the first set of decision trees and the second set of decision trees. Aspects of the technology using this method provide for even greater reduced variation, while still maintaining a final output prediction that is based on the new, more relevant data, resulting in a highly precise and highly accurate predictive model.

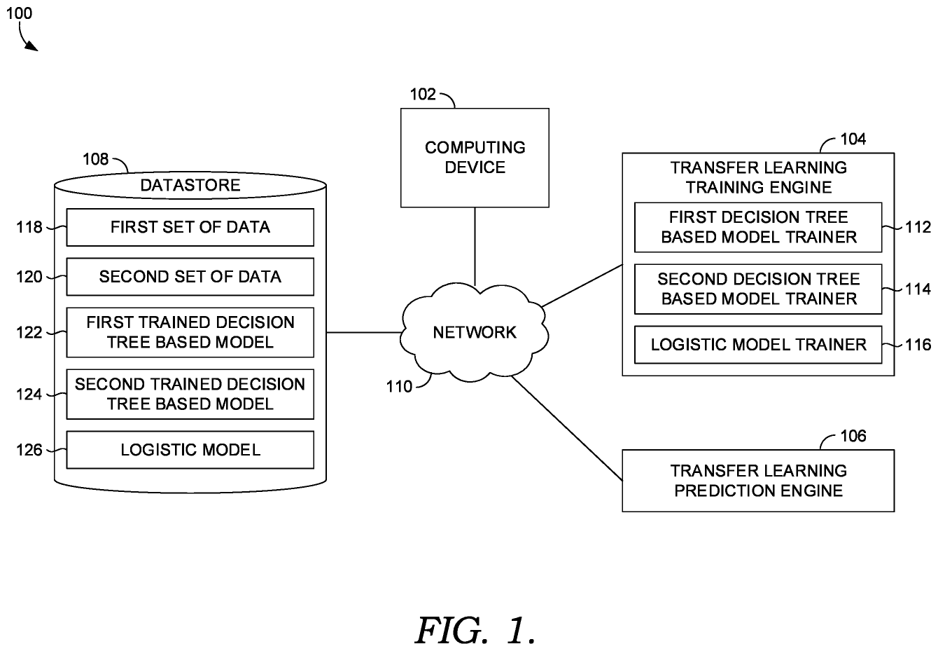

With reference now to FIG. 1, FIG. 1 is an example operating environment 100 in which decision tree based models using transfer learning can be employed. Operating environment 100 comprises computing device 102, which can execute transfer learning training engine 104 and transfer learning prediction engine 106. Operating environment 100 further comprises datastore 108. Components of FIG. 1 communicate via network 110.

Network 110 may include one or more networks (e.g., public network or virtual private network “VPN”) as shown with network 110. Network 110 may include, without limitation, one or more local area networks (LANs) wide area networks (WANs), or any other wired or wireless communication network or method.

Having identified various components of operating environment 100, it is noted that any additional or fewer components, in any arrangement, may be employed to achieve the desired functionality within the scope of the present disclosure. Although components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, many of the elements described in relation to FIG. 1, such as those described in relation to transfer learning training engine 104 and transfer learning prediction engine 106, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory. Moreover, the functions described in relation to FIG. 1 may be performed a front-end (client-side), back-end (server-side), or both, and in any combination.

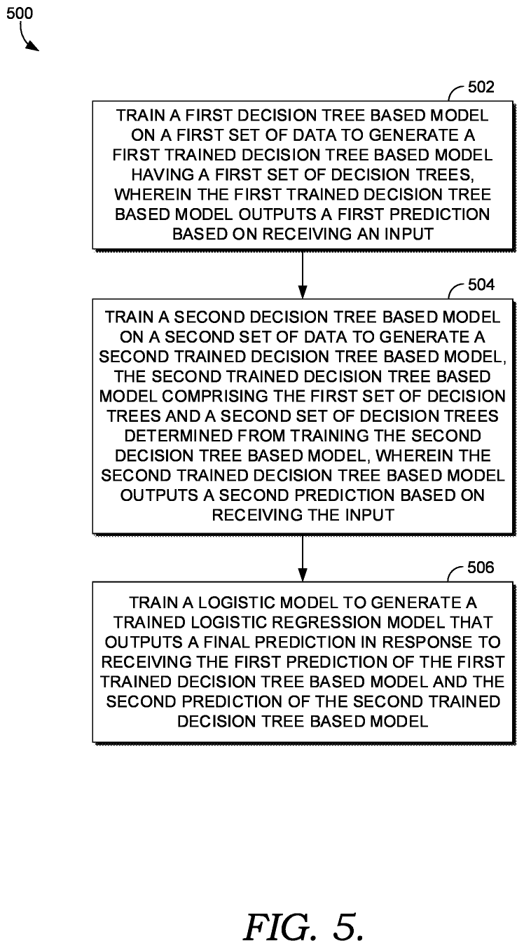

In general, computing device 102 may be a device that corresponds to the computing device 500 described with reference to FIG. 5. In implementations, computing device 102 may be a client-side or front-end device, while in other implementations computing device 102 represents a back-end or server-side device. As discussed, computing device 102 may also represent one or more computing devices, and as such, some variations of the technology comprise both a client-side or front-end device, and a back-end or server-side computing device performing functions that will be further described.

Operating environment 100 comprises datastore 108. Datastore 108 generally stores information including data, computer instructions (e.g., software program instructions, routines, or services), or models used in embodiments of the described technologies. Although depicted as a single database component, datastore 108 may be embodied as one or more data stores or may be in the cloud. Datastore 108 can comprise machine-readable instructions corresponding to transfer learning training engine 104 and transfer learning prediction engine 106. Further, datastore 108 can store other data useable by transfer learning training engine 104 and transfer learning prediction engine 106 to perform functions that will be described in more detail.

Transfer learning training engine 104 generally trains machine learning models. Transfer learning training engine 104 accesses data stored at datastore 108 to train machine learning models, including decision tree based models and logistic models. Transfer learning training engine 104 comprises first decision tree based model trainer 112, second decision tree based model trainer 114, and logistic model trainer 116. Transfer learning training engine 104 can be used to train decision tree based models, logistic models, or other like models that may be used in implementations of the technology.

A decision tree based model is any machine learning model that uses a decision tree during a training process (e.g., a learning process) or when employed to make a prediction based on its training. One example of a decision tree based model that has been identified as particularly useful with the present technology is based on LightGBM (light gradient boosting machine). This model is beneficial in that it employs methods that are computationally less intensive than some other decision tree based models; however, it still has relatively good performance when compared to other models. Additional example decision tree based models can be based on categorical variable learning or continuous variable learning. Some specific examples of these include models based on iForest (isolation forest), random forest, XGboost (extreme gradient boosting), CatBoost (categorical boosting), AdaBoost (adaptive boosting), and so forth.

A logistic model is intended to include any statistical model using a logistic function to fit data. A logistic model can be based on logistic regression. In many cases, the logistic model is a logistic classifier. That is, it outputs a predicted classification for the input. The classification may be a binary classification decision in some implementations.

First decision tree based model trainer 112 generally trains a first decision tree based model to generate a first trained decision tree based model. First decision tree based model trainer 112 can access a first set of data 118 stored at datastore 108 and the first decision tree based model is trained using first set of data 118.

First set of data 118 may comprise a labeled dataset. The labeled dataset may be suitable for use with various supervised or semi-supervised training methods. In some implementations, first set of data 118 comprises user attributes associated with user accounts. The user attributes may be any information associated with a user or the user account. This may include information such as demographic information, geographic information, economic information, and the like. In a particular use case, the user attributes can also comprise service usage event data that relates to a subscription service, such as how long a user account has subscribed, the cost of the service, subscription service promotions dates, when or if a user account has canceled the subscription, and the like. A label can be associated with the user account indicating an account event, such as an event that will ultimately be predicted by a machine learning model when trained on first set of data 118. The label associated with the user account can indicate whether the user account has canceled the subscription service, which may include an indication of when the user canceled the subscription service or how long the subscription service was active.

First decision tree based model trainer 112 can train a first decision tree based model using first set of data 118. To do so, first decision tree based model trainer 112 can employ a supervised or semi-supervised training method to generate a first set of decision trees associated with the first trained decision tree based model determined as a result of the training. When training, first decision tree based model trainer 112 can specify a number of decision trees that are generated as a result of the training. Any number can be used, but one example could include limiting a first set of decision trees to 100 decision trees.

The first set of decision trees generated as a result of the training can be used to predict the probability of or classify an event. For instance, when the first trained decision tree based model is provided an input, the input is passed through the first set of decision trees to output a predicted event responsive to the input. In a particular implementation, the input comprises user attributes associated with an account, and the output prediction comprises an indication whether a user account will cancel a subscription within a particular time period.

Second decision tree based model trainer 114 generally trains a second decision tree based model to generate a second trained decision tree based model. In doing so, second decision tree based model trainer 114 can access second set of data 120 stored at datastore 108 and the second decision tree based model is trained using second set of data 120.

Second set of data 120 may comprise data similar to first set of data 118. Second set of data 120 may be collected at a time after first set of data 118 is collected. Said differently, first set of data 118 may be collected at a time prior to second set of data 120. As such, second set of data 120 may include some data that is temporally newer relative to first set of data 118. Thus, for instance, second set of data 120 may similarly comprise user attributes for user accounts associated with labels indicating an event. For example, the user attributes of the user account may comprise service usage data, among other attributes, and a label indicating whether the user account has canceled a subscription service.

Second decision tree based model trainer 114 can train a second decision tree based model using second set of data 120. Second decision tree based model trainer 114 can employ a supervised or semi-supervised training method to generate a second set of decision trees associated with the second trained decision tree based model determined from the result of the training. When training, second decision tree based model trainer 114 can specify a number of decision trees to be generated responsive to the training. Any number of decision trees may be specified. While any number of decision trees may be specified, one example includes 150 decision trees, 100 of which could be associated with the previously trained first trained decision tree based model.

In some embodiments, second decision tree based model trainer 114 may specify a number of decision trees that is greater than the number of decision trees learned by first decision tree based model trainer 112 when training the first decision tree based model. The number of decision trees specified may include a number of decision trees within the first set of decision trees. Second decision tree based model trainer 114 can generate a second set of decision trees when training. The second set of decision trees can comprise the first set of decision trees learned by first decision tree based model trainer 112 and additional decision trees learned from training the second trained decision tree based model. The additional decision trees can be learned from second set of data 120 responsive to the training. Further, in some training implementations, a subsequent decision tree may be learned based on a previously learned decision tree. In this way, the additional decision trees generated during training can be learned based on the first set of decision trees.

The second set of decision trees can be generated as a result of training the second decision tree based model and can be used to predict the probability of or classify an event. For instance, when the second trained decision tree based model is provided an input, the input is passed through the second set of decision trees to output a predicted event responsive to receiving the input. In a particular implementation, the input comprises user attributes associated with a user account, and the output prediction comprises an indication whether the user account will cancel a subscription within a particular time period.

First decision tree based model trainer 112 and second decision tree based model trainer 114 can each employ leaf-wise tree growth (e.g., loss-guided tree growth) as a training method when respectively training the first decision tree based model and the second decision tree based model. In other implementations, first decision tree based model trainer 112 and second decision tree based model trainer 114 can each employ level-wise tree growth. Both may be employed in some embodiments.

During training, first decision tree based model trainer 112 and second decision tree based model trainer 114 can each be configured to determine a loss change for each tree node of a plurality of tree nodes in a decision tree, as the decision tree is being generated as part of the training. The loss can be determined using a loss function (e.g., an objective function). In implementations, a log loss function can be used to determine the change in loss. A log loss function is generally suitable when making binary decisions. Other loss functions, such as mean absolute error, mean squared error, and so forth, can be used with regression analyses. In general, the loss is calculated when splitting a node of the decision tree when the decision tree is being generated during training. The node split can occur where the split results in the highest gain relative to other potential tree node splits. That is, the split that has the relatively greatest impact on minimizing the loss function.

The first trained decision tree based model comprising the first set of decision trees can be stored as first trained decision tree based model 122 in datastore 108 for use by components of FIG. 1 in making a prediction. The second trained decision tree based model comprising the second set of decision trees can be stored as second trained decision tree based model 124 in datastore 108 for use by components of FIG. 1 in making a prediction.

As noted, transfer learning training engine 104 may also train a logistic model, such as a logistic regression classifier for use in implementations of the technology. To do so, transfer learning training engine 104 may employ logistic model trainer 116. Logistic model trainer 116 can train a logistic model using second set of data 120. In some embodiments, a smaller amount of data is used to train the logistic model than used to train the decision tree based models. As such, a subset of the data within second set of data 120, which is less than the total amount of data, can be used to train the logistic model. In some embodiments, the subset of data within second set of data 120 is a portion of the data that is not used by second decision tree based model trainer 114.

For example, a subset of data from second set of data 120 having a known event outcome, such as whether a user account has canceled a subscription, can be input into first trained decision tree based model 122 and second trained decision tree based model 124, which each output a probability of the event occurring. Each probability value can be labeled with the known outcome to generate a labeled dataset for training the logistic model.

By training the logistic model, logistic model trainer 116 identifies a logistic curve, for instance, by using a maximum likelihood analysis. The logistic curve can be stored as logistic model 126 for use by components of FIG. 1. The logistic curve can be fit to predict, e.g., classify, a binary event outcome, such as whether a user account will cancel a subscription within a particular amount of time.

Having now trained the decision tree based models and the logistic model, transfer learning prediction engine 106 can be employed to make a final prediction, e.g., making a final prediction on a binary classification or the probability of an occurrence of an event.

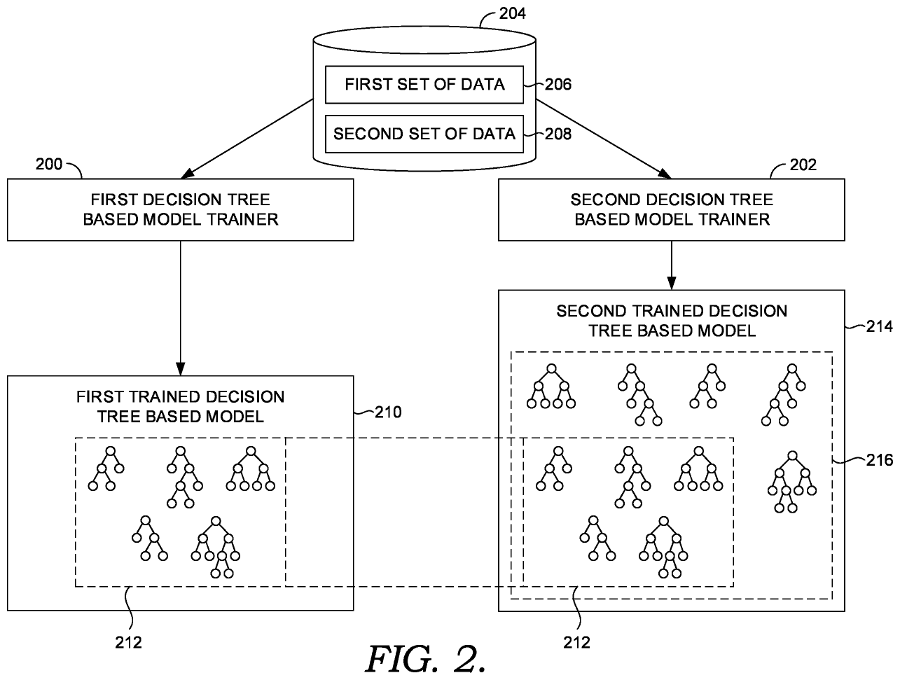

To further illustrate, FIG. 2 depicts an example process by which first decision tree based model trainer 200 and second decision tree based model trainer 202 can be utilized to respectively train first trained decision tree based model 210 and second trained decision tree based model 214.

As noted, first decision tree based model trainer 200 trains first trained decision tree based model 210 using first set of data 206. First decision tree based model trainer 112 is an example suitable for use as first decision tree based model trainer 200. First decision tree based model trainer 200 retrieves first set of data 206 from datastore 204. First set of data 118 is an example that can be used as first set of data 206. Using first set of data 206, first decision tree based model trainer 200 trains first trained decision tree based model 210, such that first trained decision tree based model 210 comprises first set of decision trees 212 learned from the training.

Second decision tree based model trainer 202 can be used to train second trained decision tree based model 212. Second decision tree based model trainer 114 is an example suitable for use as second decision tree based model trainer 202. First decision tree based model trainer 200 retrieves first set of data 206 from datastore 204. Second set of data 120 is an example that can be used as second set of data 208. Using second set of data 208, second decision tree based model trainer 202 trains second trained decision tree based model 216, such that second trained decision tree based model 214 comprises second set of decision trees 216, where second set of decision trees 216 comprises first set of decision trees 212 and additional decision trees learned from the training using second set of data 208.

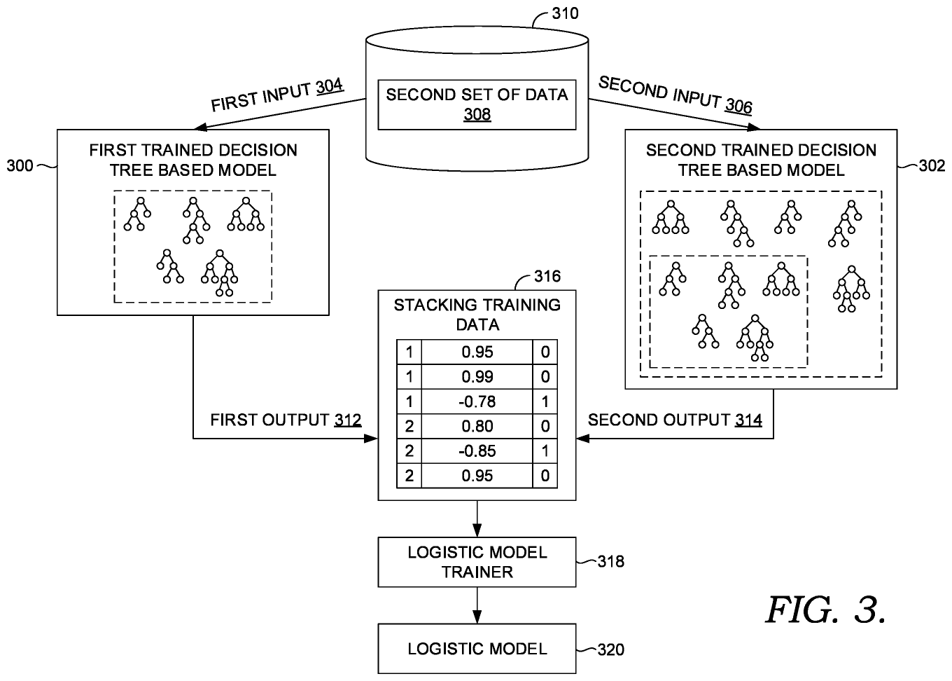

Turning now to FIG. 3, an example process for training logistic model 320 is illustrated. Here, first trained decision tree based model 300 and second trained decision tree based model 302 are used to generate stacking training data 316 for training logistic model 320.

To do so, first trained decision tree based model 300 receives first input 304 of second set of data 308 from datastore 310. As noted, when generating stacking training data 316, a portion of data from second set of data 308 may be used. Second set of data 308 may correspond to second set of data 208. More broadly, first input 304 can comprise any data having a known outcome that is collected at a time later than a first set of data, such as first set of data 206, that is used to train first trained decision tree based model 300. A portion of second set of data 308 is just one specific example that can be used by first trained decision tree based model 300 when generating stacking training data 316.

In response to receiving first input 304, first trained decision tree based model 300 generates first output 312. First output 312 comprises a probability of an event as predicted by first trained decision tree based model 300. First output 312 is associated with a label of the known event outcome for first input 304 and is provided as part of stacking training data 316. As will be discussed, one example use case is predicting churn. In this particular case, first input 304 comprises user features and a known outcome of churn or no churn (the event outcome). First trained decision tree based model 300 inputs the user features and generates first output 312, which is a probability whether there is churn or no churn. The event outcome is then used to label first output 312. First output 312 is stored in association with the event outcome label as part of stacking data 136.

Similarly, second trained decision tree based model 302 receives first input 306 of second set of data 308 from datastore 310. When generating stacking training data 316, a portion of data from second set of data 308 may be used. More broadly, second input 306 can comprise any data having a known outcome that is collected at a time later than a first set of data, such as first set of data 206, that is used to train first trained decision tree based model 300. A portion of second set of data 308 is just one specific example that can be used by second trained decision tree based model 302 when generating stacking training data 316.

In response to receiving second input 306, second trained decision tree based model 302 generates second output 314. Second output 314 comprises a probability of an event as predicted by second trained decision tree based model 302. Second output 314 is associated with a label of the known event outcome for second input 306 and is provided as part of stacking training data 316. As noted, one example use case is predicting churn. In this particular case, second input 306 comprises user features and a known outcome of churn or no churn (the event outcome). Second trained decision tree based model 302 inputs the user features and generates second output 314, which is a probability whether there is churn or no churn. The event outcome is then used to label second output 314. Second output 314 is stored in association with the event outcome label as part of stacking training data 316.

As such, stacking training data 316 can comprise a probability of an event outcome labeled with a known event outcome, and an indication of whether the probability was determined by first trained decision tree based model 300 or second trained decision tree based model 302.

Stacking training data 316 may be accessed by logistic model trainer 318. Logistic model trainer 116 is one example suitable for use as logistic model trainer 318. During training, logistic model trainer 318 can use stacking training data 316 to fit a logistic curve. Based on the training, logistic model 320 is configured to receive as inputs the outputs of first trained decision tree based model 300 and second trained decision tree based model 302, and based on the logistic curve, output a final prediction in response to the inputs. As noted, in some embodiments, a binary decision is made using the logistic curve to determine the final output of logistic model 320.

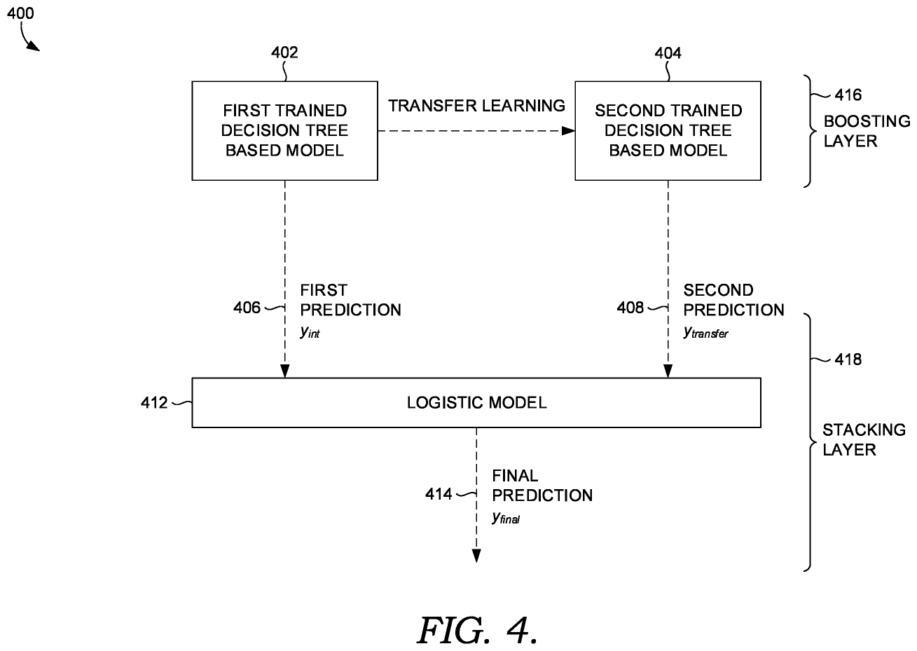

To make a final prediction, transfer learning prediction engine 106 may perform the example process 400 illustrated in FIG. 4. With reference to both FIG. 1 and FIG. 4, transfer learning prediction engine 106 can employ first trained decision tree based model 402 and second trained decision tree based model 404. First trained decision tree based model 402 is an example of a decision tree based model having been trained and stored as first trained decision tree based model 122, and likewise, second trained decision tree based model 404 is an example of a decision tree based model having been trained and stored as second trained decision tree based model 124. FIG. 4 illustrates a dashed line labeled as “transfer learning,” which is intended to illustrate the second trained decision tree based model 404 comprises a second set of decision trees that includes decision trees from a first set of decision trees of first trained decision tree based model 402 and additional decision trees learned from a second set of data. In aspects, first trained decision tree based model 210 of FIG. 2 may be used as first trained decision tree based model 402, while second trained decision tree based model 214 may be used as second trained decision tree based model 404.

As illustrated in process 400, transfer learning prediction engine 106 employs first trained decision tree based model 402 to generate first prediction (yᵢₙₜ) 406. That is, first trained decision tree based model 402 outputs first prediction (yᵢₙₜ) 406 in response to receiving an input. The input can be user attributes associated with a user account, as previously described. Further, transfer learning prediction engine 106 employs second trained decision tree based model 404 to generate second prediction (y_{transfer}) 408. That is, second trained decision tree based model 404 outputs second prediction (y_{transfer}) 408 in response to receiving the input. The input can be user attributes associated with a user account, and the input may be the same input provided to first trained decision tree based model 402. The inputs into first trained decision tree based model 402 and second trained decision tree based model 404 to generate the outputs comprising first prediction (yᵢₙₜ) 406 and second prediction (y_{transfer}) 408 can be referred to as operations performed within boosting layer 216.

Continuing with process 400, transfer learning prediction engine 106 generates final prediction (y_{final}) 414 using logistic model 412. That is, logistic model 412 generates final prediction (y_{final}) 414 responsive to receiving first prediction (yᵢₙₜ) 406 and second prediction (y_{transfer}) 408. As noted, logistic model 212 may be a logistic classifier, and final prediction (y_{final}) 414 may be a binary output of whether an event will occur. Also, as illustrated, those operations that include first prediction (yᵢₙₜ) 406 and second prediction (y_{transfer}) 408 being received by logistic model 412 to output final prediction (y_{final}) 414 may be considered as operations performed within stacking layer 418. Logistic model 320 is example suitable for use as logistic model 412.

In a particular use case, first trained decision tree based model 402 and second trained decision tree based model 404 each receive an input of user attributes associated with a user account. The respective outputs, first prediction (yᵢₙₜ) 406 and second prediction (y_{transfer}) 408, may be a numerical value indicating the probability of a user account canceling a subscription service. First prediction (yᵢₙₜ) 406 and second prediction (y_{transfer}) 408 can be provided to logistic model 412. In this particular use case, logistic model 412 is configured to classify the inputs as a user account that is likely to cancel a subscription service or a user account that is not likely to cancel a subscription service, thus providing an indication whether a user account associated with the user attributes will cancel the subscription service within a particular time period.

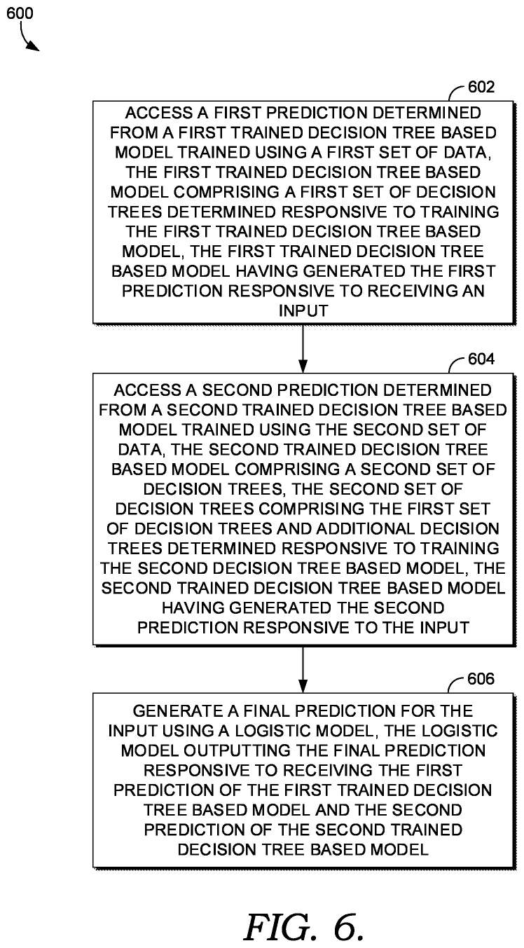

FIGS. 5 and 6 are provided to illustrate methods for using decision tree based model transfer learning to predict an event, such as whether a user will cancel a subscription service. The methods may be performed using components of FIG. 1, such as transfer learning training engine 104 or transfer learning prediction engine 106. In embodiments, one or more computer storage media having computer-executable instructions embodied thereon that, when executed, by one or more processors, cause the one or more processors to perform operations of the methods.

FIG. 5 illustrates an example method 500 for training decision tree based models and a logistic model using transfer learning, such that the trained models are configured to predict an event. At block 502, a first decision tree based model is trained on a first set of data. The training generates a first trained decision tree based model. The first trained decision tree based model comprises a first set of decision trees. The first set of decision trees is learned during training of the first decision tree based model. First decision tree based model trainer 112 can be employed to train the first decision tree based model. First set of data 118 of FIG. 1 is an example of the first set of data that may be used to train the first decision tree based model. Based on the training, the first trained decision tree based model is configured to output a first prediction based on receiving an input.

At block 504, a second decision tree based model is trained on a second set of data. The training generates a second trained decision tree based model. The second trained decision tree based model comprises a second set of decision trees. The second set of decision trees comprises the first set of decision trees learned at block 502. In some embodiments, the second set of decision trees comprises a portion of the first set of decision trees. The second set of decision trees further comprises additional decision trees that are determined responsive to training the second decision tree based model on the second set of data. Second decision tree based model trainer 114 can be employed to train the second decision tree based model. Second set of data 120 of FIG. 1 is an example of the second set of data that may be used to train the second decision tree based model. As a result of the training, the second trained decision tree based model is configured to output a second prediction based on receiving the input. In some implementations, the input for the first trained decision tree based model is the same as the second trained decision tree based model.

In some embodiments, the first trained decision tree based model and the second trained decision tree based model are based on LightGBM. The first trained decision tree based model and the second trained decision tree based model may be trained using leaf-wise tree growth. In some embodiments, during training a loss change for the tree nodes is determined and a tree node split resulting in the greatest loss change, such as the greatest loss minimization (e.g., greatest gain), is identified and the tree node is split based on the greatest loss change.

At block 506, a logistic model is trained. Logistic model trainer 116 of FIG. 1 may be used to train a logistic model. In some case, the logistic model is trained on a subset of data from the second set of data, such as second set of data 120. This may include data that was not used to train the second decision tree based model. As an example, the subset of data can include data having a known event outcome. The subset of data can be provided to the first trained decision tree based model and the second trained decision tree based model. The outputs of these models can be labeled with the known outcome of the event. The logistic model can be trained using the labeled data to generate a logistic curve. Based on the training, the logistic model is configured to receive the first prediction and the second prediction and output a final prediction. The logistic model may operate as a binary classifier. The logistic model may be a logistic regression model.

In a particular example of the technology, the event predicted by the models is whether a user account is likely to cancel a subscription service. To do so, during training, the first set of data and the second set of data comprise user attributes, including service usage event data, that are associated with user accounts. The user accounts are labeled to indicate whether the user account has canceled a subscription within a particular time period, and may be labeled to indicate when the user account was canceled or how long the user account was active, for example. Based on this, the first trained decision tree based model and the second trained decision tree based model may be configured to output a probability that the user account will cancel the subscription service within the particular time period. The logistic model is configured to receive the first and second predictions as inputs and output a final prediction, such a final binary indication, whether the user account will cancel the subscription service within the particular time period.

FIG. 6 illustrates an example method 600 for predicting an event, such as whether a user will cancel a subscription service. At block 602, a first prediction is accessed or otherwise determined. The first prediction can be determined from a first trained decision tree based model that has been trained using a first set of data. First trained decision tree based model 122 trained using first set of data 118 is one suitable example. The first trained decision tree based model comprises a first set of decision trees determined responsive to the training. The first trained decision tree based model can generate the first prediction in response to receiving an input.

At block 604, a second prediction is accessed or otherwise determined. The second prediction can be determined from a second trained decision tree based model that has been trained using a second set of data. Second trained decision tree based model 124 trained using second set of data 120 is one suitable example. The second trained decision tree based model comprises a second set of decision trees. The second set of decision trees may comprise the first set of decision trees, or a portion thereof, and additional decision trees learned responsive to training the second decision tree based model on the second set of data. The second trained decision tree based model may have generated the second prediction in response to receiving the input. In some implementations, the input to the second trained decision tree based model is the same input provided to the first trained decision tree based model.

In some embodiments, the first trained decision tree based model and the second trained decision tree based model are based on LightGBM. In some implementations, the input provided to the first trained decision tree based model and the second trained decision tree based model is a set of user attributes associated with a user account. The first prediction may comprise a probability of the user account canceling a subscription service within a particular time period. Similarly, the second prediction may comprise a probability of the user account canceling the subscription service within the particular time period.

At block 606, a final prediction is generated. The final prediction may be generated using a logistic model. The logistic model may be a logistic regression classifier. The logistic model outputs the final prediction, which may be a binary classification, responsive to receiving the first prediction and the second prediction as inputs. The logistic model may be configured to generate the final prediction based on training the logistic model. Logistic model 126 trained using logistic model trainer 116 of FIG. 1 is a suitable example. In some embodiments, the logistic model is trained on a subset of the second set of data. In a specific implementation, the logistic model receives, as the first prediction, a probability that a user account will cancel a subscription service as determined by the first trained decision tree based model, and receives, as a second prediction, a probability that the user account will cancel the subscription service as determined by the second trained decision tree based model. Based on receiving these inputs, the logistic model can output an indication whether a user account will cancel a subscription service within a particular period of time.

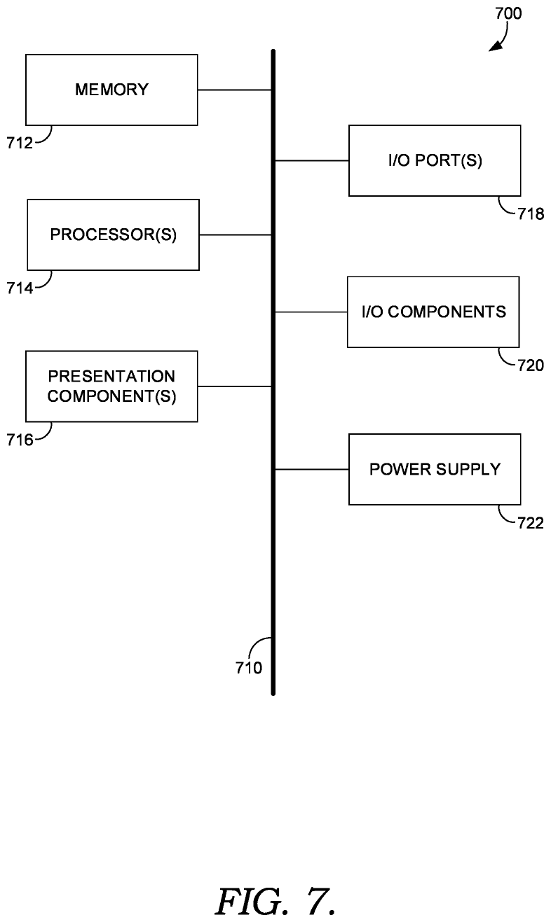

Having described an overview of embodiments of the present technology, an example operating environment in which embodiments of the present technology may be implemented is described below in order to provide a general context for various aspects. Referring initially to FIG. 7, in particular, an example operating environment for implementing embodiments of the present technology is shown and designated generally as computing device 700. Computing device 700 is but one example of a suitable computing environment and is not intended to suggest any limitation as to the scope of use or functionality of the technology. Neither should computing device 700 be interpreted as having any dependency or requirement relating to any one or combination of components illustrated. Computing device 700 is intended to represent one or more computing devices, including those operating within a cloud-based platform.

The technology of the present disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more busses (such as an address bus, data bus, or combination thereof).

Although the various blocks of FIG. 7 are shown with lines for the sake of clarity, in reality, delineating various components is not so clear, and metaphorically, the lines would more accurately be grey and fuzzy. For example, one may consider a presentation component, such as a display device, to be an I/O component. As another example, processors may also have memory. Such is the nature of the art, and it is again reiterated that the diagram of FIG. 7 is merely an example computing device that can be used in connection with one or more embodiments of the present technology. Distinction is not made between such categories as “workstation,” “server,” “laptop,” “hand-held device,” etc., as all are contemplated within the scope of FIG. 7 in reference to “computing device.”

Computing device 700 typically includes a variety of computer-readable media. Computer-readable media can be any available media that can be accessed by computing device 700 and includes both volatile and nonvolatile media, and removable and non-removable media. By way of example, and not limitation, computer-readable media may comprise computer storage media and communication media.

Computer storage media include volatile and nonvolatile, removable and non-removable media implemented in any method or technology for storage of information, such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile or nonvolatile memory. The memory may be removable, non-removable, or a combination thereof. Example hardware devices include solid-state memory, hard drives, optical-disc drives, etc. Computing device 700 includes one or more processors that read data from various entities such as memory 712 or I/O components 720. Presentation component(s) 716 present data indications to a user or other device. Examples of presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, and so forth. Power supply 722 may include any power source, or be illustrative of a terminal to a power source, suitable for powering one or more components of FIG. 7. Radio(s) 724 is illustrative of any device that may facilitate wireless communication to or with components of FIG. 7, including a receiver, transmitter, or a combination of both.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies.

Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having,” or derivatives thereof, has the same broad meaning as the word “comprising,” and the word “accessing,” or derivatives thereof, comprises “receiving,” “referencing,” or “retrieving.” Further, the word “communicating,” or derivatives thereof, has the same broad meaning as the word “receiving” or “transmitting” facilitated by software or hardware-based buses, receivers, or transmitters using communication media. Also, the word “initiating,” or derivatives thereof, has the same broad meaning as the word “executing” or “instructing,” where the corresponding action can be performed to completion or interrupted based on an occurrence of another action.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the described schematics, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated in the accompanying drawings is to be interpreted as illustrative and not in a limiting sense.

What is claimed is:

1. A system comprising:
a memory component; and
a processing device, operatively coupled to the memory component, to perform operations comprising:
training a first decision tree based model on a first set of data to generate a first trained decision tree based model having a first set of decision trees, wherein the first trained decision tree based model outputs a first prediction based on receiving an input;
training a second decision tree based model on a second set of data to generate a second trained decision tree based model, the second trained decision tree based model comprising a second set of decision trees that includes the first set of decision trees and additional decision trees determined from training the second decision tree based model on the second set of data, wherein the second trained decision tree based model outputs a second prediction based on receiving the input; and
training a logistic model to output a final prediction in response to receiving the first prediction of the first trained decision tree based model and the second prediction of the second trained decision tree based model.

2. The system of claim 1, wherein the first trained decision tree based model and the second trained decision tree based model are each based on LightGBM (Light Gradient Boosting Machine).

3. The system of claim 1, wherein the first set of data is collected at a time prior to collection of the second set of data.

4. The system of claim 1, wherein the operations further comprise training the logistic model on a portion of the second set of data.

5. The system of claim 1, wherein the logistic model is a logistic classifier.

6. The system of claim 1, wherein training the first decision tree based model and training the second decision tree based model comprises leaf-wise tree growth.

7. The system of claim 1, wherein training the first decision tree based model and training the second decision tree based model comprises:
determining a loss change for each of a plurality of tree nodes; and
splitting a tree node of the plurality of tree nodes based on the tree node split having a greatest loss change.

8. A non-transitory computer-readable storage media storing computer-executable instructions that when executed by a processing device, cause the processing device to perform operations comprising:
accessing a first prediction determined from a first decision tree based model trained using a first set of data, the first decision tree based model comprising a first set of decision trees determined responsive to training the first decision tree based model, the first decision tree based model having generated the first prediction responsive to receiving an input;
accessing a second prediction determined from a second decision tree based model trained using a second set of data, the second decision tree based model comprising a second set of decision trees, the second set of decision trees comprising the first set of decision trees and additional decision trees determined responsive to training the second decision tree based model, the second decision tree based model having generated the second prediction responsive to the input; and
generating a final prediction for the input using a logistic model, the logistic model outputting the final prediction responsive to receiving the first prediction of the first decision tree based model and the second prediction of the second decision tree based model.

9. The media of claim 8, wherein the first decision tree based model and the second decision tree based model are each based on LightGBM (Light Gradient Boosting Machine).

10. The media of claim 8, wherein the logistic model is a logistic classifier.

11. The media of claim 8, wherein the input comprises user attributes.

12. The media of claim 11, wherein the logistics model comprises a logistic curve fit to predict a binary event outcome.

13. The media of claim 8, wherein the logistic model is trained on at least a portion of the second set of data.

14. A method performed by one or more processors, the method comprising:
determining, using a first decision tree based model trained on a first set of data, a first prediction responsive to the first decision tree based model receiving an input, the first decision tree based model comprising a first set of decision trees determined responsive to training the first decision tree based model;
determining, using a second decision tree based model trained on a second set of data, a second prediction responsive to the second decision tree based model receiving the input, the second decision tree based model comprising a second set of decision trees, the second set of decision trees comprising the first set of decision trees and additional decision trees determined responsive to training the second decision tree based model; and
generating, using a logistic model, a final prediction for the input responsive to the logistic model receiving the first prediction and the second prediction.

15. The method of claim 14, wherein the first decision tree based model and the second decision tree based model are each based on LightGBM (Light Gradient Boosting Machine).

16. The method of claim 14, wherein the logistic model is a logistic regression model.

17. The method of claim 14, wherein the logistic model is a logistic classifier.

18. The method of claim 14, wherein the first set of data is collected at a time prior to collection of the second set of data.

19. The method of claim 14, wherein the input comprises user attributes.

20. The method of claim 19, wherein the logistics model comprises a logistic curve fit to predict a binary event outcome.
